(19) United States
(12) Patent Application Publication
(10) Pub. No.: US 2022/0391446 A1
(43) Pub. Date: Dec. 8, 2022

(54) METHOD AND DEVICE FOR DATA SHARING

(71) Applicant: BEIJING DAJIA INTERNET INFORMATION TECHNOLOGY CO., LTD., Beijing (CN)

(72) Inventor: Xiao TANG, Beijing (CN)

(21) Appl. No.: 17/890,815

(22) Filed: Aug. 18, 2022

Related U.S. Application Data
(63) Continuation of application No. PCT/CN2021/075617, filed on Feb. 5, 2021.

(30) Foreign Application Priority Data
Feb. 20, 2020 (CN) 202010104833.8

(51) Int. Cl. G06F 16/904; G06F 16/9035

(52) U.S. Cl. CPC G06F 16/904; G06F 16/9035

(57) ABSTRACT

A method for data sharing and a device are provided. The method includes: receiving a data sharing instruction, the data sharing instruction carrying a user identifier; obtaining, according to the data sharing instruction, a labelled data set corresponding to the user identifier and satisfying a preset condition; receiving at least one piece of labelled data to be shared selected from the labelled data set; obtaining at least one piece of address data corresponding to the at least one piece of labelled data to be shared; and sending the at least one piece of address data to a client corresponding to the user identifier, to enable the client to share the at least one piece of address data.

### CROSS-REFERENCE TO RELATED APPLICATION

The present application is a continuation application of International Application No. PCT/CN2021/075617, filed on Feb. 5, 2021, which claims a priority to Chinese Patent Application No. 202010104833.8, filed on Feb. 20, 2020.

### FIELD

The present disclosure relates to the field of data transmission technology, and in particular to a method for data sharing and a device.

### BACKGROUND

With rapid progress of modern information transmission technology and popularity of video capture devices such as smart phones, enthusiasm of people for sharing life through creating videos has developed unprecedentedly. When browsing videos, pictures or text information, users often find a lot of information desired to share (such as short video works), and share any content desired to share with a help of a certain data sharing method.

### SUMMARY

The present disclosure provides a method for data sharing and a device.

According to a first aspect of embodiments of the present disclosure, a method for data sharing is provided. The method includes:

receiving a data sharing instruction, the data sharing instruction carrying a user identifier;

obtaining, according to the data sharing instruction, a labelled data set corresponding to the user identifier and satisfying a preset condition;

receiving at least one piece of labelled data to be shared selected from the labelled data set;

obtaining at least one piece of address data corresponding to the at least one piece of labelled data to be shared; and

sending the at least one piece of address data to a client corresponding to the user identifier, to enable the client to share the at least one piece of address data.

According to a second aspect of embodiments of the present disclosure, a method for data sharing is provided. The method includes:

displaying a labelled data set corresponding to a user identifier and satisfying a preset condition in response to a data sharing instruction carrying the user identifier;

obtaining at least one piece of labelled data to be shared selected from the labelled data set, and uploading the at least one piece of labelled data to be shared to a server;

receiving at least one piece of address data corresponding to the at least one piece of labelled data to be shared which is returned by the server; and

sharing the at least one piece of address data.

According to a third aspect of embodiments of the present disclosure, a client is provided. The client includes:

a processor;

a memory configured to store instructions executable by the processor; in which, the processor is caused to implement the following method when executing the executable instructions:

displaying a labelled data set corresponding to a user identifier and satisfying a preset condition in response to a data sharing instruction carrying the user identifier;

obtaining at least one piece of labelled data to be shared selected from the labelled data set, and uploading the at least one piece of labelled data to be shared to a server;

receiving at least one piece of address data corresponding to the at least one piece of labelled data to be shared which is returned by the server; and

sharing the at least one piece of address data.

It should be understood that the above general description and the following detailed description are only exemplary and explanatory, and cannot limit the present disclosure.

### BRIEF DESCRIPTION OF THE DRAWINGS

The drawings here are incorporated into the specification and constitute a part of the specification, show embodiments conforming to the disclosure, and together with the specification are used to explain the principle of the disclosure, and do not constitute an improper limitation of the disclosure.

FIG. 1 is a flowchart illustrating a method for data sharing according to an illustrative embodiment of the present disclosure.

FIG. 2 is a flowchart illustrating a method for data sharing according to an illustrative embodiment of the present disclosure.

FIG. 3 is a block diagram illustrating an apparatus for data sharing according to an illustrative embodiment of the present disclosure.

FIG. 4 is a block diagram illustrating an apparatus for data sharing according to an illustrative embodiment of the present disclosure.

FIG. 5 is a block diagram illustrating an electronic device for data sharing according to an illustrative embodiment of the present disclosure.

FIG. 6 is a block diagram illustrating an electronic device for data sharing according to an illustrative embodiment of the present disclosure.

### DETAILED DESCRIPTION

In order to enable those skilled in the art to understand the technical solution of the present disclosure, reference will be made clearly and completely technical solutions in the embodiments of the present disclosure with accompanying drawings.

It should be noted that terms “first” and “second” in the specification and claims of the present disclosure and the accompanying drawings are used to distinguish similar objects, rather than to describe a specific order or sequence. It should be understood that data used in such a manner may be interchanged under appropriate circumstances so that embodiments of the present disclosure described herein may be implemented in a sequence other than the sequence illustrated or described herein. The implementations described in the following exemplary embodiments do not represent all implementations consistent with the present disclosure; instead, the implementations described in the following exemplary embodiments are merely examples of an apparatus and method consistent with the attached claims and some aspects of the present disclosure.

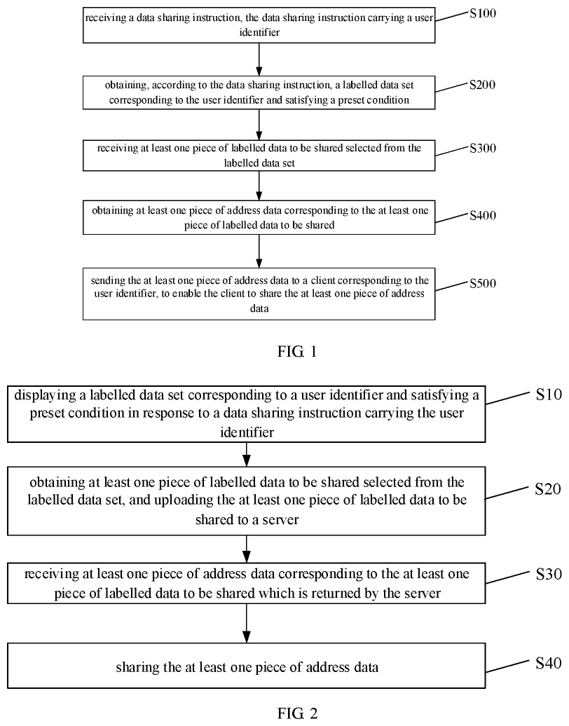

FIG. 1 is a flowchart illustrating a method for data sharing according to an illustrative embodiment of the present disclosure. As illustrated in FIG. 1, the method includes the following blocks.

At block S100, a data sharing instruction is received. The data sharing instruction carries a user identifier.

At block S200, a labelled data set corresponding to the user identifier and satisfying a preset condition is obtained according to the data sharing instruction.

At block S300, at least one piece of labelled data to be shared selected from the labelled data set is received.

At block S400, at least one piece of address data corresponding to the at least one piece of labelled data to be shared is obtained.

At block S500, the at least one piece of address data is sent to a client corresponding to the user identifier, to enable the client to share the at least one piece of address data.

The data sharing instruction is an instruction for indicating sharing data which is generated by the client of a user. The user identifier may be a registered account of the user or other information that uniquely identifies an identity of the user, such as a mobile phone number, an identity number, a WeChat account, etc. The preset condition may be a certain period of time or a certain number of times of browsing. Since data desired to share by the user is generally data or information browsed in the certain period of time (e.g., a previous period of time or a certain day) or with a relatively large number of browsing, setting the certain period of time or the certain number of times of browsing herein helps to quickly locate data or information desired to share. The labelled data set is a set of a plurality of data or information (e.g., short video works) that the user may desire to share. Data in the data set may include a plurality of types of data, such as positive comments, negative comments, neutral comments, etc., which may be data labeled with likes by the user. Or, the data in the data set may include data with a certain type which is desired to share by the use (e.g., the label herein may be regarded as the type of data). For example, when the user desires to share some short video works that the user gives likes due to interesting, the labelled data set may be a set of short video works that the user gives the likes. When the user desires to share some short video works of a certain type, the labelled data set may be a set of short video works of a certain type, or the labelled data set may also be a set of some pictures, texts and other information. The specific type of the labelled data set is not limited herein. The labelled data to be shared may be data corresponding to the labelled data to be shared which is determined by the client of the corresponding user according to the labelled data set. The address data may be data that identifies a storage address of a certain labelled data to be shared (e.g., a certain short video work).

In some embodiments, taking the short video as an example, a button of sharing videos in batches is set on a video playing page of the client. The data sharing instruction may be generated by clicking the button of sharing videos in batches by the user, and the data sharing instruction is sent to a server. The server may obtain, according to the received data sharing instruction, the labelled data set that satisfies the preset condition and is consistent with a direction of the data sharing instruction. For example, after receiving the data sharing instruction, works browsed by the user within 12 hours (e.g., the labelled data set satisfying the preset condition) may be obtained.

After obtaining the labelled data set that satisfies the preset condition (the works browsed within 12 hours), the client displays a tag or a video cover corresponding to the labelled data set, to enable the user to select the short video work desired to share according to short video works displayed on the client. For example, the user may select the labelled data (e.g., the short video work) desired to share according to the labelled data set presented on the client (e.g., the short video works within 12 hours), to obtain a set of data as the labelled data to be shared. The client may generate the labelled data to be shared according to an operation of the user, and send the labelled data to be shared to the server. The server may determine the address data corresponding to data to be shared. The address data may be an address corresponding to the short video work desired to share by the user. The server sends a link corresponding to the address data to the client, and shares, via the client, the address data in the form of the link to an interface or a user desired to share.

The method for data sharing may include receiving the data sharing instruction, and the data sharing instruction carries the user identifier; obtaining the labelled data set corresponding to the user identifier and satisfying the preset condition according to the data sharing instruction; receiving the at least one piece of labelled data to be shared selected from the labelled data set; obtaining the at least one piece of address data corresponding to the at least one piece of labelled data to be shared; sending the at least one piece of address data to the client corresponding to the user identifier, to enable the user identifier to share the at least one piece of address data. Thus, the at least one piece of address data is send to the client corresponding to the user identifier, to enable the user identifier to share the at least one piece of address data. Multiple contents may be shared simultaneously without sharing the at least one piece of labelled data to be shared one by one.

In an illustrative embodiment, it is an implementation of the block S200. Obtaining, according to the data sharing instruction, the labelled data set corresponding to the user identifier and satisfying the preset condition includes:

obtaining, according to the data sharing instruction, a data set to be processed corresponding to the user identifier; and filtering out the labelled data set satisfying the preset condition from the data set to be processed.

The data set to be processed may be a set of all data (such as the short video works, the pictures, etc.) labeled (such as given the like) by the user.

In some embodiments, after receiving the data sharing instruction, the data set to be processed corresponding to the user identifier may be obtained according to the data sharing instruction, and the data set to be processed may be filtered to select the labelled data set satisfying the preset condition.

In some embodiments, the data set to be processed corresponding to the user identifier within the preset period of time may be obtained according to the data sharing instruction. The preset period of time may be set according to requirements, which is not limited in this disclosure.

For example, all short video works that user has been given the like according to the received data sharing instructions, and short video works within nearly 12 hours are filtered out from all short video works that user has been given the like.

According to the above illustrative embodiment, the data set to be processed corresponding to the user identifier is obtained according to the data sharing instruction, and the labelled data set satisfying the preset condition is filtered out from the data set to be processed. Since the data desired to share by user is generally the data or information browsed in a certain period of time (such as the previous period of time or a certain day) or with a relatively large number of browsing, the labelled data set is filtered through the preset condition setting with a certain period of time or a certain number of times of browsing herein, which is helpful to quickly locate the data or information desired to share by the user.

In an illustrative embodiment, it is an implementation of the block S500, sending the at least one piece of address data to the client corresponding to the user identifier, to enable the user identifier to share the at least one piece of address data includes:

sending the at least one piece of address data to the client corresponding to the user identifier; and sharing the at least one piece of address data via a data sharing function of the client.

In some embodiments, the server may generate one link based on the at least one piece of address data, send the link including the at least one piece of address data to the client corresponding to the user identifier, and share the address data in the form of the link to the interface or the user desired to share.

The above illustrative embodiment includes sending the at least one piece of address data to the client corresponding to the user identifier and sharing the at least one piece of address data via the data sharing function of the client. Therefore, the at least one piece of address data is send to the client corresponding to the user identifier, to enable the user identifier to share the at least one piece of address data. Multiple contents may be shared simultaneously without sharing the at least one piece of labelled data to be shared one by one.

FIG. 2 is a flowchart illustrating a method for data sharing according to an illustrative embodiment of the present disclosure. As illustrated in FIG. 2, the method includes the following blocks.

At block S10, a labelled data set corresponding to a user identifier and satisfying a preset condition is displayed in response to a data sharing instruction carrying the user identifier.

At block S20, at least one piece of labelled data to be shared selected from the labelled data set is obtained, and the at least one piece of labelled data to be shared is uploaded to a server.

At block S30, at least one piece of address data corresponding to the at least one piece of labelled data to be shared which is returned by the server is received.

At block S40, the at least one piece of address data is shared.

The data sharing instruction is an instruction for indicating sharing of data which is generated by the client of a user. The user identifier may be a registered account of the user or other information that uniquely identifies an identity of the user, such as a mobile phone number, an identity number, a WeChat account, etc. The preset condition may be a certain period of time or a certain number of times of browsing. Since data desired to share by the user is generally data or information browsed in the certain period of time (e.g., a previous period of time or a certain day) or with a relatively large number of browsing, setting the certain period of time or the certain number of times of browsing herein helps to quickly locate data or information desired to share. The labelled data set is a set of a plurality of data or information (e.g., short video works) that the user may desire to share. Data in the data set may include a plurality of types of data, such as positive comments, negative comments, neutral comments, etc., which may be data labeled with likes by the user. Or, the data in the data set may include data with a certain type which is desired to share by the use (e.g., the label herein may be regarded as the type of data). For example, when the user desires to share some short video works that the user gives likes due to interesting, the labelled data set may be a set of short video works that the user gives the likes. When the user desires to share some short video works of a certain type, the labelled data set may be a set of short video works of a certain type, or the labelled data set may also be a set of some pictures, texts and other information. The specific type of the labelled data set is not limited herein. The labelled data to be shared may be data corresponding to the labelled data to be shared which is determined by the client of the corresponding user according to the labelled data set. The address data may be data that identifies a storage address of a certain labelled data to be shared (e.g., a certain short video work).

In some embodiments, taking the short video as an example, a button of sharing videos in batches is set on a video playing page of the client. The data sharing instruction may be generated by clicking the button of sharing videos in batches by the user, and the data sharing instruction is sent to a server. The server may obtain, according to the received data sharing instruction, the labelled data set that satisfies the preset condition and is consistent with a direction of the data sharing instruction. For example, after receiving the data sharing instruction, works browsed by the user within 12 hours (e.g., the labelled data set satisfying the preset condition) may be obtained.

After obtaining the labelled data set that satisfies the preset condition (the works browsed within 12 hours), the client displays a tag or a video cover corresponding to the labelled data set, to enable the user to select the short video work desired to share according to short video works displayed on the client. For example, the user may select the labelled data (e.g., the short video work) desired to share according to the labelled data set presented on the client (e.g., the short video works within 12 hours), to obtain a set of data as the labelled data to be shared. The client may generate the labelled data to be shared according to an operation of the user, and send the labelled data to be shared to the server. The server may determine the address data corresponding to data to be shared. The address data may be an address corresponding to the short video work desired to share by the user. The server sends a link corresponding to the address data to the client, and shares, via the client, the address data in the form of the link to an interface or a user desired to share.

The method for data sharing may include displaying the labelled data set corresponding to the user identifier and satisfying the preset condition in response to the data sharing instruction carrying the user identifier; obtaining the at least one piece of labelled data to be shared selected from the labelled data set, and uploading the at least one piece of labelled data to be shared to the server; receiving the at least one piece of address data corresponding to the at least one piece of labelled data to be shared which is returned by the server; and sharing the at least one piece of address data. Therefore, the client receives the at least one piece of address data and shares the at least one piece of address data through the user identify. Multiple contents may be shared simultaneously without sharing the at least one piece of labelled data to be shared one by one.

In an illustrative embodiment, it is an implementation before the block S10. Generating the data sharing instruction by the client includes:

displaying a data sharing control on a client where the user identifier is logged in; and obtaining a trigger operation for the data sharing control, and generating the data sharing instruction according to the trigger operation;

In some embodiments, taking the short video as an example, the data sharing control (e.g., a button of sharing videos in batches) is set on a video playing page of the client. The data sharing instruction may be generated by clicking the data sharing control by the user, and the data sharing instruction is sent to the server. Thus, it may provide the user with an operation tip for data sharing in batches, which is convenient to initiate the data sharing in batches.

In an illustrative embodiment, it is an implementation of the block S20. Obtaining the at least one piece of labelled data to be shared selected from the labelled data set includes:

selecting the at least one piece of labelled data to be shared from the labelled data set in response to an operation instruction generated via an interface of a client.

In some embodiments, after the labelled data set corresponding to the user identifier and satisfying the preset condition is displayed on the client, the user may select the labelled data (e.g., the short video work) desired to share according to the labelled data set presented on the client (e.g., the short video works within 12 hours), to obtain a set of data as the labelled data to be shared. The labelled data to be shared is sent to the server. The labelled data to be shared may be the data corresponding to the labelled data desired to share which is determined by the client of the corresponding user according to the labelled data set. A receiver of the data to be share may be one or more. A set of a plurality of contacts may be displayed on the client, and one or more contacts selected from the contact set may be obtained for sharing.

According to the above illustrative embodiment, the at least one piece of labelled data to be shared is selected from the labelled data set in response to the operation instruction generated via the interface of the client, which may provide a data base for subsequent data sharing, so as to finally realize a purpose of sharing multiple contents simultaneously.

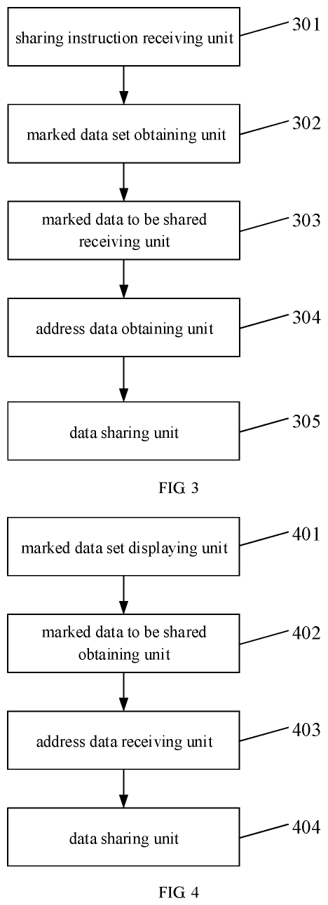

FIG. 3 is a block diagram illustrating an apparatus for data sharing according to an illustrative embodiment of the present disclosure. Referring to FIG. 3, the apparatus includes a sharing instruction receiving unit 301, a labelled data set obtaining unit 302, a labelled data to be shared receiving unit 303, an address data obtaining unit 304 and a data sharing unit 305.

The sharing instruction receiving unit 301 is configured to perform receiving a data sharing instruction, the data sharing instruction carrying a user identifier.

The labelled data set obtaining unit 302 is configured to perform obtaining, according to the data sharing instruction, a labelled data set corresponding to the user identifier and satisfying a preset condition.

The labelled data to be shared receiving unit 303 is configured to perform receiving at least one piece of labelled data to be shared selected from the labelled data set.

The address data obtaining unit 304 is configured to perform obtaining at least one piece of address data corresponding to the at least one piece of labelled data to be shared.

The data sharing unit 305 is configured to perform sending the at least one piece of address data to a client corresponding to the user identifier, to enable the user identifier to share the at least one piece of address data.

In an illustrative embodiment, the labelled data set obtaining unit 302 is further configured to perform:

obtaining, according to the data sharing instruction, a data set to be processed corresponding to the user identifier; and

filtering out the labelled data set satisfying the preset condition from the data set to be processed.

In an illustrative embodiment, the labelled data set obtaining unit 302 is further configured to perform:

obtaining, according to the data sharing instruction, the data set to be processed corresponding to the user identifier within a preset period of time.

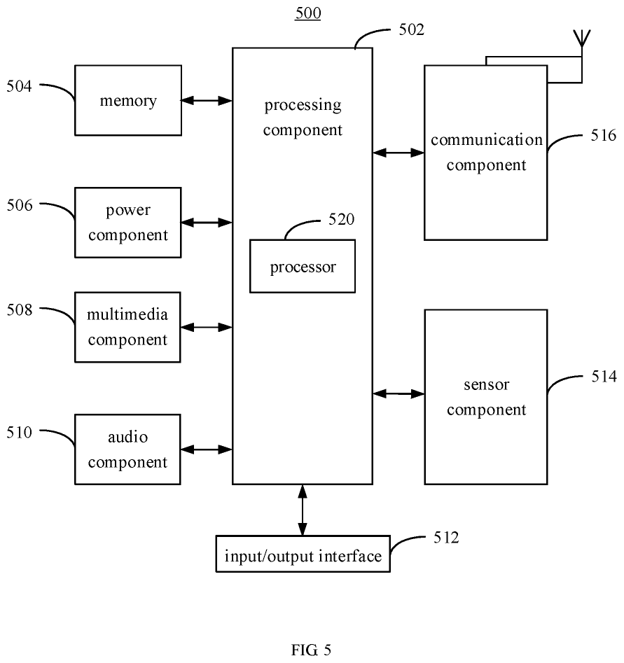

FIG. 4 is a block diagram illustrating an apparatus for data sharing according to an illustrative embodiment of the present disclosure. Referring to FIG. 4, the apparatus includes a labelled data set displaying unit 401, a labelled data to be shared obtaining unit 402, an address data receiving unit 403 and a data sharing unit 404.

The labelled data set displaying unit 401 is configured to perform displaying a labelled data set corresponding to a user identifier and satisfying a preset condition in response to a data sharing instruction carrying the user identifier.

The labelled data to be shared obtaining unit 402 is configured to perform obtaining at least one piece of labelled data to be shared selected from the labelled data set, and uploading the at least one piece of labelled data to be shared to a server.

The address data receiving unit 403 is configured to perform receiving at least one piece of address data corresponding to the at least one piece of labelled data to be shared which is returned by the server.

The data sharing unit 404 is configured to perform sharing the at least one piece of address data.

In an illustrative embodiment, the apparatus further includes a sharing instruction generating unit, configured to perform:

displaying a data sharing control on a client where the user identifier is logged in; and

obtaining a trigger operation for the data sharing control, and generating the data sharing instruction according to the trigger operation;

In an illustrative embodiment, the labelled data to be shared obtaining unit 402 is further configured to perform:

selecting the at least one piece of labelled data to be shared from the labelled data set in response to an operation instruction generated via an interface of a client.

As for the apparatus in the above embodiment, a specific way in which each unit performs the operation has been described in detail in the embodiment of the method, and will not be described in detail herein.

FIG. 5 is a block diagram illustrating an electronic device 500 for data sharing according to an illustrative embodiment of the present disclosure. The electronic device may be a device having the client described in the above embodiment. For example, the device 500 may be a mobile phone, a computer, a digital broadcasting terminal, a messaging device, a game console, a tablet device, a medical equipment, a fitness equipment, a personal digital assistant, etc.

As illustrated in FIG. 5, the device 500 may include one or more of the following components: a processing component 502, a memory 504, a power component 506, a multimedia component 508, an audio component 510, an input/output (I/O) interface 512, a sensor component 514 and a communication component 516.

The processing component 502 typically controls overall operations of the device 500, such as the operations associated with display, telephone calls, data communications, camera operations, and recording operations. The processing component 502 may include one or more processors 520 to execute instructions. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the apparatus 1000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. When the device 500 is in operation mode, such as shooting mode or video mode, the front camera or the rear camera may receive the external multimedia data. Each front camera and rear camera may be a fixed optical lens system or an optical lens system with focal length and optical zoom capacity.

The audio component 510 is configured to output and/or input audio signals. For example, the audio component 510 includes a microphone (“MIC”) configured to receive an external audio signal when the electronic device 500 is in an operation mode, such as a call mode, a recording mode, and a voice recognition mode. The received audio signal may be further stored in the memory 504 or transmitted via the communication component 516. In some embodiments, the audio component 510 also includes a speaker for outputting an audio signal.

The I/O interface 512 provides an interface between the processing component 502 and peripheral interface modules, such as a keyboard, a click wheel, buttons, and the like. These buttons may include, but not limited to, a Home button, a volume button, a start button and a lock button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of a target object contact with the device 500, an orientation or an acceleration/deceleration of the device 500, and a change in temperature of the device 500. The sensor component 514 may include a proximity sensor, which is configured to detect the existence of the objects nearby without any physical contact. The sensor component 514 may further include a light sensor such as a CMOS or CCD image sensor, which is configured to use in imaging applications. In some embodiments, the sensor component 514 may further include an acceleration transducer, a gyroscope sensor, a magnetic sensor, a pressure sensor or a temperature sensor.

The communication component 516 is configured to facilitate communication, wired or wirelessly, between the device 500 and other devices. The device 500 may access a wireless network based on a communication standard, such as WiFi, 2G, or 3G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identity (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, which is configured to perform the above method.

In an exemplary embodiment, a storage medium is further provided which includes instructions, such as the memory 504 including instructions, in which the instructions may be executed by the processor 520 of the device 500 to complete the above methods. The storage medium may be a non-temporary computer readable storage medium. For example, the non-temporary computer readable storage medium may be a ROM, a random access memory (RAM), a CD-ROM, a magnetic tape, a floppy disk, an optical data storage device, etc.

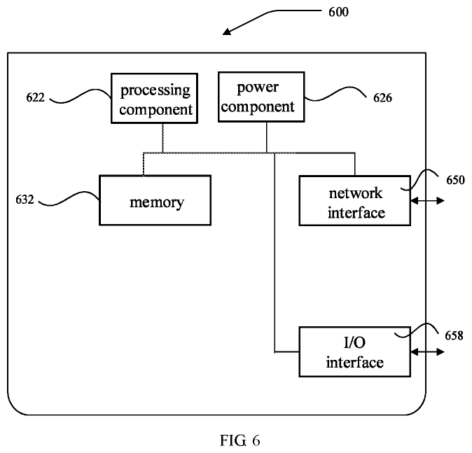

FIG. 6 is a block diagram illustrating an electronic device 600 for data sharing according to an illustrative embodiment of the present disclosure. The device 600 may be provided as a server. Referring to FIG. 6, the device 600 includes a processing component 622, which further includes one or more processors, and a memory resource represented by a memory 632, for storing instructions that can be executed by the processing component 622, such as application programs. The application program stored in the memory 632 may include one or more modules each corresponding to a set of instructions. In addition, the processing component 622 is configured to execute instructions to execute a method for data sharing described in any of the foregoing embodiments.

The device 600 may also include a power component 626 configured to perform power management of the device 600, a wired or wireless network interface 650 configured to connect the device 600 to a network, and an input output (I/O) interface 658. The device 600 can operate based on an operating system stored in the memory 632, such as Windows Server™, MacOS X™, Unix™, Linux™, FreeBSD™ or the like.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope of the present disclosure. It is intended that the scope of the present disclosure only be limited by the attached claims.

1. A method for data sharing, comprising:
receiving a data sharing instruction, the data sharing instruction carrying a user identifier;
obtaining, according to the data sharing instruction, a labelled data set corresponding to the user identifier and satisfying a preset condition;
receiving at least one piece of labelled data to be shared selected from the labelled data set;
obtaining at least one piece of address data corresponding to the at least one piece of labelled data to be shared; and
sending the at least one piece of address data to a client corresponding to the user identifier, to enable the client to share the at least one piece of address data.

2. The method according to claim 1, wherein said obtaining, according to the data sharing instruction, the labelled data set corresponding to the user identifier and satisfying the preset condition comprising:
obtaining, according to the data sharing instruction, a data set to be processed corresponding to the user identifier; and
selecting the labelled data set satisfying the preset condition from the data set to be processed.

3. The method according to claim 2, wherein said obtaining, according to the data sharing instruction, the data set to be processed corresponding to the user identifier comprising:
obtaining, according to the data sharing instruction, the data set to be processed corresponding to the user identifier within a preset period of time.

4. The method according to claim 2, wherein said obtaining, according to the data sharing instruction, the data set to be processed corresponding to the user identifier comprising:
obtaining, according to the data sharing instruction, the data set to be processed corresponding to the user identifier within greater than a certain number of times of browsing.

5. The method according to claim 2, wherein the data set to be processed is a set of data labelled by a user corresponding to the user identifier.

6. The method according to claim 1, wherein the labelled data set is a set of data with a certain type, the type is labelled by a user corresponding to the user identifier.

7. The method according to claim 1, further comprising:
sending the labelled data set to the client to enable the client to display a tag or a video cover corresponding to the labelled data set.

8. A method for data sharing, comprising:
displaying a labelled data set corresponding to a user identifier and satisfying a preset condition in response to a data sharing instruction carrying the user identifier;
obtaining at least one piece of labelled data to be shared selected from the labelled data set, and uploading the at least one piece of labelled data to be shared to a server;
receiving at least one piece of address data corresponding to the at least one piece of labelled data to be shared which is returned by the server; and
sharing the at least one piece of address data.

9. The method according to claim 8, further comprising:
displaying a data sharing control on a client where the user identifier is logged in; and
obtaining a trigger operation for the data sharing control, and generating the data sharing instruction according to the trigger operation.

10. The method according to claim 8, wherein said obtaining the at least one piece of labelled data to be shared selected from the labelled data set comprises:
selecting the at least one piece of labelled data to be shared from the labelled data set in response to an operation instruction generated via an interface of a client.

11. The method according to claim 8, wherein the labelled data set is obtained from a data set to be processed corresponding to the user identifier based on the preset condition, and the data set to be processed is a set of data labelled by a user corresponding to the user identifier.

12. The method according to claim 8, wherein the labelled data set is a set of data with a certain type, the type is labelled by a user corresponding to the user identifier.

13. The method according to claim 8, further comprising:
displaying a tag or a video cover corresponding to the labelled data set.

14. A client, comprising:
a processor;
a memory configured to store instructions executable by the processor; wherein,
the processor is caused to implement the following method when executing the executable instructions:
displaying a labelled data set corresponding to a user identifier and satisfying a preset condition in response to a data sharing instruction carrying the user identifier;
obtaining at least one piece of labelled data to be shared selected from the labelled data set, and uploading the at least one piece of labelled data to be shared to a server;
receiving at least one piece of address data corresponding to the at least one piece of labelled data to be shared which is returned by the server; and
sharing the at least one piece of address data.

15. The client according to claim 14, wherein the processor is caused to implement:
displaying a data sharing control on a client where the user identifier is logged in; and
obtaining a trigger operation for the data sharing control, and generating the data sharing instruction according to the trigger operation.

16. The client according to claim 14, wherein the processor is caused to implement:
selecting the at least one piece of labelled data to be shared from the labelled data set in response to an operation instruction generated via an interface of a client.

17. The client according to claim 14, wherein the labelled data set is obtained from a data set to be processed corresponding to the user identifier based on the preset condition, and the data set to be processed is a set of data labelled by a user corresponding to the user identifier.

18. The client according to claim 14, wherein the labelled data set is a set of data with a certain type, the type is labelled by a user corresponding to the user identifier.

19. The client according to claim 14, wherein the processor is caused to implement:
displaying a tag or a video cover corresponding to the labelled data set.
